(19) United States
(12) Patent Application Publication
(10) Pub. No.: US 2025/0310212 A1
(43) Pub. Date: Oct. 2, 2025

(54) SYSTEM AND METHOD FOR DETECTING LOAD CHANGES IN A RADIO ACCESS NETWORK

(71) Applicant: Verizon Patent and Licensing Inc., Basking Ridge, NJ (US)

(72) Inventors: Jason A Birr, Lithia, FL (US); Hector A Garcia Crespo, North Richland Hills, TX (US); Ammara Essa, Los Angeles, CA (US); Brian A Ward, Fort Worth, TX (US)

(21) Appl. No.: 18/616,702

(22) Filed: Mar. 26, 2024

(51) Int. Cl. H04L 41/147; H04L 41/16; H04W 24/08

(52) U.S. Cl. CPC H04L 41/147; H04L 41/16; H04W 24/08

(57) ABSTRACT

One or more methods and/or systems for detecting loading changes are provided. First data is gathered from a wireless cell site. The first data may be indicative of loading of the wireless cell site. Changepoints in the first data may be detected. The first data may be analyzed to obtain indications of causes of the changepoints. The causes may be seasonal events and/or non-seasonal events. A determination of the causes may be made using the indications.

### BACKGROUND

Wireless communication services, such as cellular services, wireless internet services, etc. may be used by organizations, companies, universities and other entities to interconnect people, machines, vehicles, sensors and other devices.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an example environment in which at least a portion of the techniques presented herein may be utilized and/or implemented, wherein the environment includes wireless cell sites, user equipment, a network and a loading analysis & forecasting system;

FIG. 2A is a flow chart illustrating a first part of an example method for analyzing loading data for a cell site to detect a changepoint and determine what caused it;

FIG. 2B is a flow chart illustrating a second part of the example method for analyzing loading data for the cell site to detect a changepoint and determine what caused it;

FIG. 3 is a plot of z-scores versus time from an analysis of loading data of a cell site, wherein a cluster of z-scores is shown;

FIG. 4 is a plot of z-scores versus time from an analysis of loading data of a cell site, wherein two clusters of z-scores are shown;

FIG. 5 is a multi-year plot of loading data from a cell site;

FIG. 6 shows a plot of loading data from a cell site, wherein a plurality of changepoints have been identified;

FIG. 7 shows an envelope pattern that has been determined for the plot of FIG. 6;

FIG. 8 is a schematic diagram of an instance of a model component of the loading analysis & forecasting system;

FIG. 9, shows a training data set that may be used to train a training model;

FIG. 10A is a flow chart illustrating a first part of an example method for analyzing loading data for a cell site to detect a changepoint, determine what caused it and use that determination for forecasting;

FIG. 10B is a flow chart illustrating a second part of the example method for analyzing loading data for the cell site to detect the changepoint, determine what caused it and use that determination for forecasting;

FIG. 11 is an illustration of a scenario featuring an example non-transitory machine-readable medium in accordance with one or more of the provisions set forth herein; and

FIG. 12 is an example environment in which systems and/or methods described herein may be implemented.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The methods herein may be performed by or in conjunction with the foregoing.

The following provides a discussion of some types of scenarios in which the disclosed subject matter may be utilized and/or implemented.

The present disclosure relates to an environment having a wireless communication network, which may be divided into geographic areas, or cells. Each cell may include one or more wireless communication sites (or simply “cell sites”) that send and receive wireless radio transmissions to and from end user devices, i.e., user equipment (UE). UEs may be mobile or fixed. Each cell site may include a base station that controls low-level operation of a plurality of UEs that are wirelessly connected to the base station. One or more base stations may be part of a radio access network (RAN), which may be connected to a core network operated by a telecommunication service provider. The core network may be connected to an external network, such as the Internet and/or cloud services. The telecommunication network may extend throughout a nation or a certain geographical area.

It is important to have historical data in order to accurately forecast key performance indicators (KPIs) of RAN usage in a network or portion thereof for network planning and enhancement. The historical data may be time series data comprising a sequence taken at successive equally spaced points in time (e.g., hourly, daily. weekly, etc.). The need for historical data is particularly important when machine learning applications are used for making such forecasts. However, accurate forecasting requires historic changes in cell loading/capacity to be identified in the data. The identified load changes permit the historical data to be adjusted (rescaled) to account for the changes in load, thereby facilitating the generation of more accurate forecasts. Load changes may be identified through the detection of changepoints in the historical data. The historical data preceding the changepoint may be rescaled using mean scaling or another type of scaling.

A load change at a cell site may be an onload type of change, i.e., more traffic is being taken on by a cell, or an offload type of change, i.e., less traffic is being taken on by a cell. Generally, loading changes may result from network changes or seasonal changes. One type of network change may be the addition of new capacity in or near an existing sector of a cell (an offload type of change). New capacity may result from new builds, the addition of small cells and/or carrier additions. Another type of network change may be the modification of RAN equipment, such as through software updates and/or changes in load balancing parameters. Other network changes may include changes in radio power and/or the implementation of radio frequency optimization measures.

An example of a seasonal change may be the loading of a cell site that provides service to a winter resort. The loading may be high every winter season, e.g. December through March, but then precipitously declines during the off-season, e.g., April through November. Another example may be a cell site providing service to a university. The loading may be high during a school term, such as from September through May, but then markedly decreases during the summer months, e.g., June through August. More generally, seasonality refers to regular, repeating patterns that occur at fixed intervals.

If historical data is rescaled without regard to the nature of a loading change, the use of the rescaled data to produce a forecast may lead to unsatisfactory results. For example, if a loading change is seasonal, rescaling the historical data before the changepoint of the loading change may produce a forecast that is less accurate than if no rescaling had been performed at all.

In the methods and systems described herein, loading changes are analyzed to determine whether they are due to network changes or seasonal changes and only those loading changes determined to be due to network changes are utilized to rescale historical data. More specifically, changepoints are identified and then analyzed to determine whether the changepoints pertain to network changes or seasonal changes. For those changepoints pertaining to network changes, the historical data preceding the changepoints is rescaled.

In one or more of the methods disclosed herein, first data is gathered from a wireless cell site. The first data is indicative of loading of the wireless cell site. A changepoint in the first data is detected. The first data is analyzed to obtain indications relating to a cause of the changepoint. The cause can be one of a seasonal event or a non-seasonal event. The cause of the changepoint is identified based on the indications.

Also, in one or more of the methods disclosed herein, first data is gathered from a wireless cell site for a first time period. A changepoint is detected in the first data. The first data is analyzed to obtain indications relating to a cause of the changepoint. The cause of the changepoint is identified based on the indications. The first data is utilized based on the identifying of the cause of the changepoint. The utilizing of the first data comprises one of creating generated data and adjusting the first data.

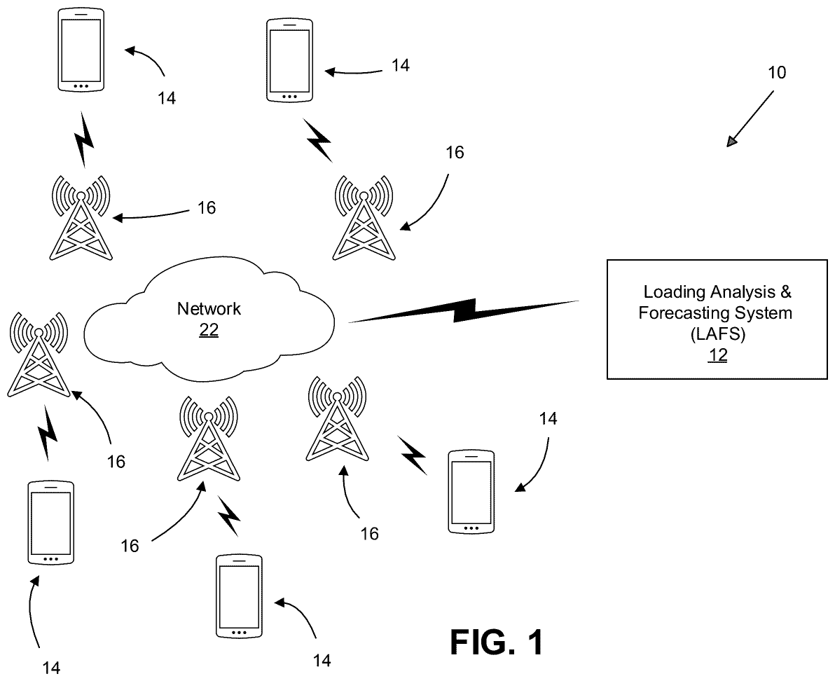

FIG. 1 is a diagram of an example environment 10 in which systems and/or methods described herein may be implemented. As illustrated, environment 10 may include a loading analysis and forecasting (LAF) system 12 and user equipment (UE) 14 associated with cell sites 16. The cell sites 16 may be part of one or more RANs which may be connected to a core network, which, in turn, may be connected to an external network, such as the Internet and/or cloud services. Devices/networks of environment 10 may be interconnected via wired connections, wireless connections, or a combination of wired and wireless connections. These connections may be collectively referred to as network 22.

Components of environment 10 may have a Universal Mobile Telecommunications System (UMTS) or third generation (3G) architecture, a long-term evolution (LTE) or fourth generation (4G) architecture, a new radio (NR) or fifth generation (5G) architecture, or a combination of the foregoing.

Each UE 14 may comprise a mobile phone, a laptop computer, a tablet computer, a desktop computer, or other type of wireless communication device. Each UE 14 may include a transceiver circuit operable to transmit/receive signals to/from a connected cell site 16 via one or more antenna. Each UE 14 may further include a user interface, memory and a controller. The controller in each UE 14 controls the operation of the UE 14 in accordance with software stored in memory.

Each cell site 16 has a base station that includes transceiver circuitry operable to transmit/receive wireless signals to/from connected UEs 14 via one or more antenna. Each base station may also be operable to transmit/receive signals to/from other wireless communication sites 16 and/or a core network through one or more appropriate interfaces, such as a site-site interface and/or a site-core network interface. Signals may be transmitted/received to/from other wireless communication sites and/or a core network wirelessly or through hard connections, such as cable or fiber optic connections. One or more controllers may control the operation of each cell site 16 in accordance with software stored in memory. A cell site 16 may further include infrastructure such as a tower and one or more enclosures for housing equipment, such as computers, sensors, etc.

Depending on the architecture of the network component it is a part of a cell site 16 may be a Node B site, an eNodeB (eNB) site, a gNodeB (gNB) site or another type of site that provides cellular communications. More specifically, if a network component has a 3G architecture, a cell site 16 in the network component may be a Node B site; if a network component has a 4G architecture, a cell site 16 in the network component may be an eNB site; and if a network component has a 5G architecture, a cell site 16 in the network component may be an gNB site.

The LAF system 12 may include one or more personal computers, one or more workstation computers, one or more server devices, one or more virtual machines provided in a cloud computing environment, or one or more other types of computation and communication devices. The LAF system 12 may be installed in the environment 10 and may be in communication with all of the cell sites 16 via the network 22. In some implementations, the LAF system 12 may be associated with an entity that manages and/or operates all or a portion of the environment 10, such as, for example a telecommunication service provider.

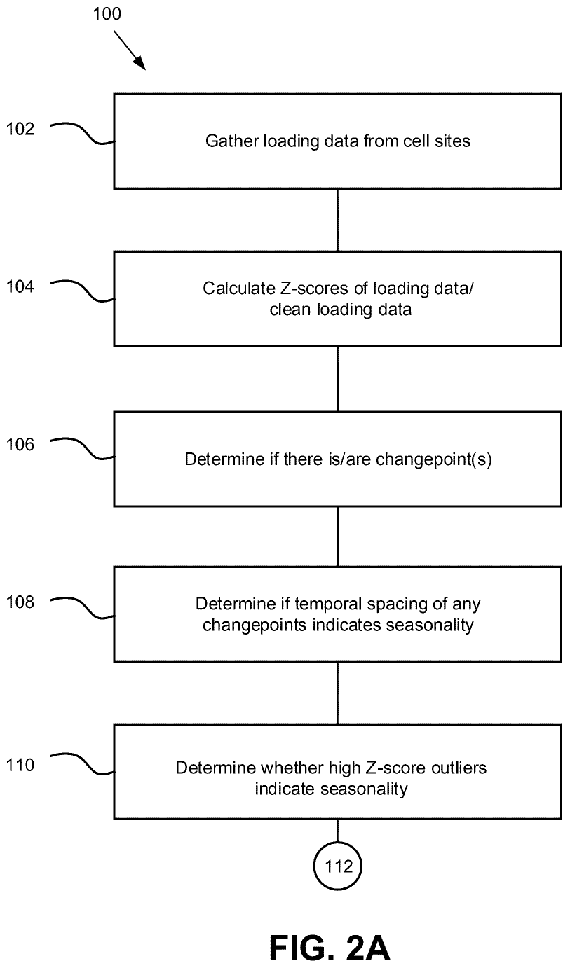

A loading analysis component of the LAF system 12 generally performs one or more methods for analyzing loading data for one or more cell sites 16 for determining whether changepoints in loading have occurred and, if so, whether the changepoints are associated with network changes or seasonal changes. An example of one of these methods is shown in FIGS. 2A and 2B and is designated with the reference numeral 100.

At 102, loading data from a cell site 16 or a plurality of cell sites 16 of interest is gathered. The loading data is time series data (i.e., a sequence) and may comprise a KPI per unit of time, such as hourly, daily or some other time period. The KPI provides a measure of loading of a cell site 16. An example of such a KPI that may be used is average active connections, i.e., average number of users (UEs 14) connected per hour in a day or other time basis (AvgAC). The AvgAC may provide a measure of the capacity of a cell site 16. Other KPIs may be used that provide a measure of the loading of a cell site 16.

At 102, loading data may be gathered from a data repository (such as data repository 520) that automatically collects and stores all historical data from the cell sites 16.

At 104, z-scores of the gathered loading data may be calculated. The z-scores may be calculated on a rolling window basis to identify high z-score instances in the loading data sequence. The z-scores may be calculated from the following:

$$z = \frac{x - μ}{ρ}$$

where x is a data value in the window, y is the mean of the data in the window and p is the standard deviation of the data in the window. Data having high z-scores may be considered outliers. These outliers may be noted and recorded for further use. The loading data may be cleaned by removing the outliers and replacing them with filler data, such as through front filling, back filling, mean filling, distribution random filling or normal distribution filling.

At 106, the cleaned loading data (sequence) may be analyzed to identify any changepoints that may have occurred. The analysis may be performed using a detection method such as binary segmentation. In binary segmentation, a single changepoint detection method is applied to all of the loading data. The changepoint detection method looks for changes of a certain magnitude in the mean, variance, or other characteristic of the data. If a changepoint is found, the loading data is split at the changepoint to create two new data sub-sequences. The changepoint detection method is applied to each data sub-sequence and if new changepoints are found, additional splits are made. The method ends when no new sub-sequences are created and the final set of changepoints is the location of all the split points.

Detection methods other than binary segmentation may be used at 106 to identify changepoints. One such other detection method that may be used is the sliding window method in which a small window of the loading data is analyzed for a step change of a certain magnitude in the mean, variance or other characteristic of the data within the window. The window “slides” across the entire loading data sequence, one time step at a time.

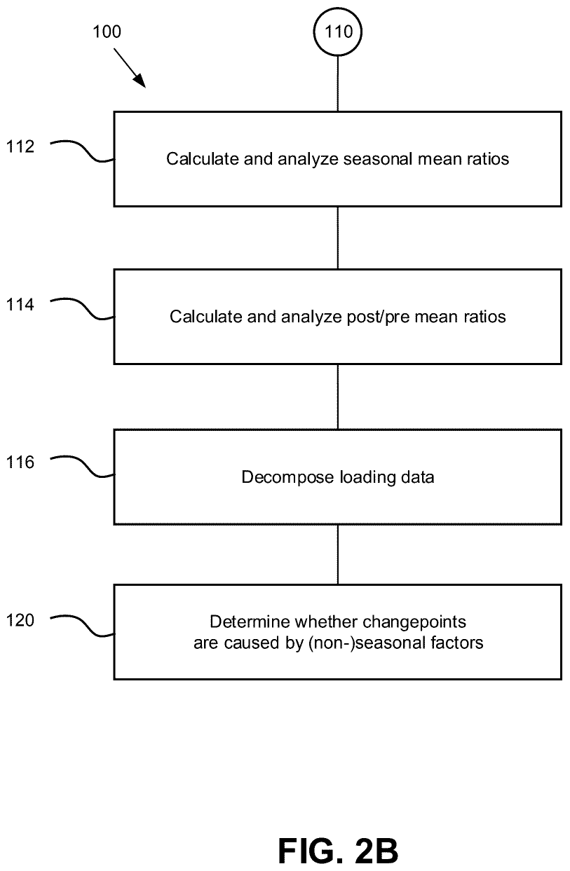

In method 100, performance at 108, 110, 112, 114 and 116 may be after 106. However, some (e.g., 110, 112) may be performed, at least in part, before 106. Although 108-116 are shown in FIGS. 2-3 in a particular order, this is not to be construed as limiting. Indeed, performance at 108-116 may be in any order. All or some of 108, 110, 112, 114 and 116 may be used to analyze gathered loading data to obtain indications of causes of any detected changepoints, e.g., a (non-)seasonal loading changes. Still further, all or some of 108, 110, 112, 114 and 116 may be used to train and use a machine learning model to detect (non-)seasonal loading changes (e.g., offload), as more fully described below.

At 108, the loading data may be analyzed in light of the changepoints detected at 106 in order to determine whether changepoints are associated with loading changes that are seasonal in nature. For example, the temporal distances between changepoints may be determined. Changepoints that are spaced apart by about a year may indicate potential seasonal loading changes.

At 110, high z-score outliers may be analyzed to determine if they indicate seasonal load changes. An analysis window of a limited time period, such as 30 days, is moved over the loading data and the number of high z-scores in each 30-day window are counted. FIG. 3 shows a plot 130 of z-scores versus time obtained from such an analysis. As shown, a significant number of high z-score outliers are clustered in a 30-day window 132. Depending on the KPI of the loading data, this type of clustering may indicate a potential seasonal pattern.

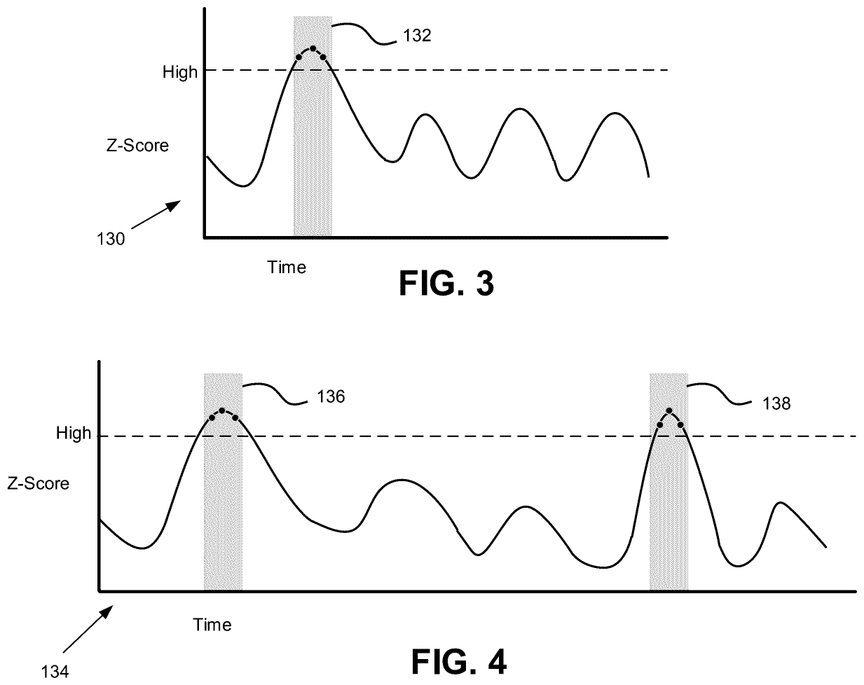

In one instance, windows with clustered high z-score outliers may be analyzed in light of their temporal relationships. FIG. 4 shows a plot 134 of z-scores versus time obtained from such analysis. Windows 136, 138 each have a cluster of high z-score outliers. The windows 136, 138 are spaced apart by about a year, which may indicate potential seasonal loading changes.

The results at 110 may be compared to the changepoints (if any) detected at 106. If windows with clustered high z-score outliers coincide with detected changepoint(s), the coincidence may be a confirmation that seasonal loading change(s) have occurred. This confirmation may be strengthened if the coinciding changepoints and windows with clustered high z-score outliers are spaced apart by about a year.

At 112, the loading data may be analyzed to calculate seasonal mean ratios.

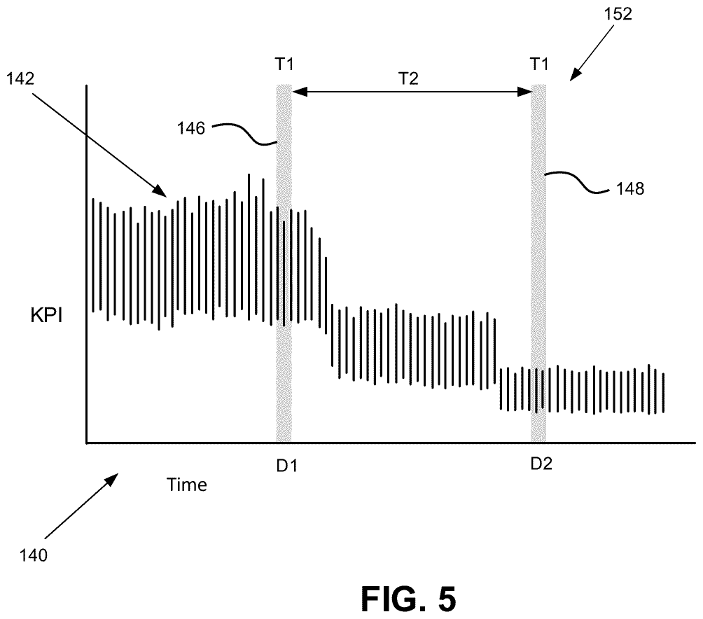

Analysis windows of a shortened time period are separated by a spacing of an elongated time period and are moved along the loading data to evaluate post/pre ratios of mean data values. An example of such analysis may be shown and described with reference to FIG. 5, which shows a multi-year plot 140 of loading data 142 from a cell site 16. A first time window 146 and a second time window 148 are separated by a time period T2 and may collectively be referred to as a window configuration 152. The first and second time windows 146, 148 each have a time period T1. Time period T1 is substantially smaller than time period T2. The window configuration 152 may be positioned over the most recent loading data and then moved backward over the loading data 142 in increments of T1. In one instance, the time period T1 may be one month and the time period T2 may be 11 months. In the example instance shown in FIG. 5, the window configuration 152 is positioned over loading data such that the first time window 146 encompasses the loading data of a first date D1 (such as September of an earlier year) and the second time window 148 encompasses loading data of a second date D2 (such as September of a more recent year). The mean of the loading data 142 in the first time window 146 may be calculated, the mean of the loading data 142 in the second time window 148 may be calculated and then the ratio of the two means may be calculated to yield a post/pre monthly mean ratio, which in the example may be a September monthly mean ratio. The window configuration 152 may then be moved backward a month to have the first and second time windows 146, 148 cover, for example, August of the earlier year and August of the current year, respectively. The means of the loading data in the first and second time windows 146, 148 may be calculated and their ratio calculated to yield, in this example, a post/pre August monthly mean ratio.

The seasonal mean ratios may be calculated beginning with the most recent seasonal mean ratio, which is calculated when the window configuration 152 is positioned over the loading data such that the second time window 148 encompasses the most recent loading data and the first time window 146 encompasses the loading data one year earlier. The window configuration 152 may then be moved backward one month at a time and the calculations made, as described above, until all of the historical loading data has been traversed, thereby yielding multiple seasonal (e.g., monthly) mean ratios.

The seasonal mean ratios calculated at 112 may be analyzed to detect significant loading changes (e.g., offloading). This analysis may include finding a maximum, a minimum and/or a mean of all the calculated seasonal mean ratios and comparing the individual seasonal mean ratios to each other and to the minimum, maximum and/or mean seasonal mean ratio(s), as well as to the most recent seasonal mean ratio. For example, with regard to the description above and the plot shown in FIG. 5, the September seasonal mean ratio is fairly high, especially compared to the minimum seasonal mean ratio. This may indicate that an offload event has occurred. The September seasonal ratio is also higher than the most recent seasonal mean ratio, which may further indicate the occurrence of an offload event that is non-seasonal.

In other instances, the time period T2 at 112 may be decreased, such as to five months. The resulting seasonal mean ratios may provide indications of seasonal load changes. For example, the seasonal mean ratios may have alternating large and small seasonal mean ratios, which may indicate seasonal load changes.

The results at 112 may be compared to the changepoints (if any) detected at 106. If large or small values of the calculated seasonal mean ratios (compared to a maximum, a minimum and/or a mean) coincide with detected changepoint(s), the coincidence may be a confirmation that loading change(s) have occurred.

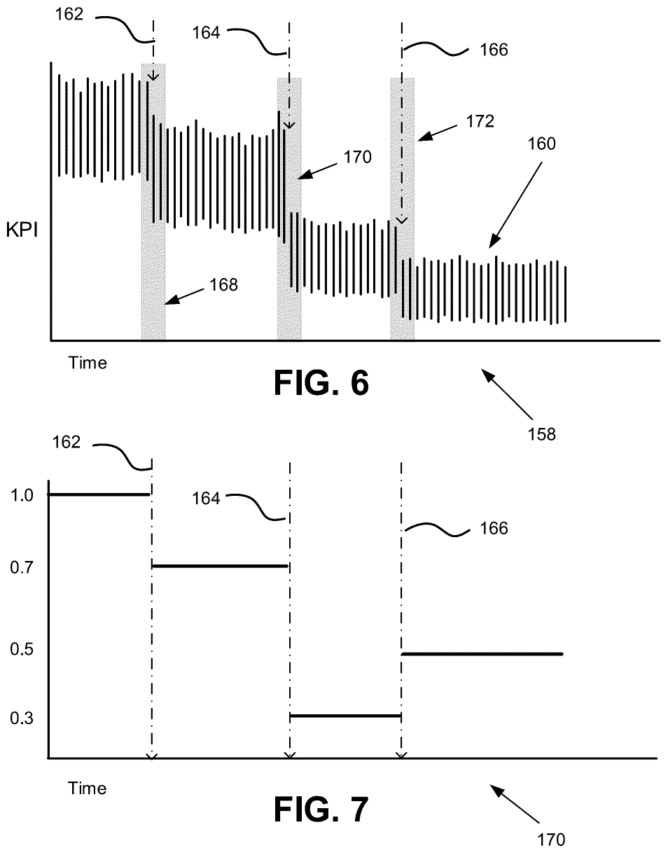

At 114, the changepoints may be analyzed to calculate post/pre mean ratios. FIG. 6 shows a plot 158 of loading data 160 from a cell site 1, wherein changepoints 162, 164, 166 have been identified. For each of the changepoints 162, 164, 166, a mean of the loading data after the changepoint is divided by the mean of the loading data before the changepoint to yield a post/pre mean ratio. For each of the changepoints 162, 164, 166, the means are calculated from a pair of windows 168, 170, 172 of loading data, respectively. For each of the pair of windows 168, 170, 172, one window immediately precedes the changepoint and one window immediately follows the changepoint. The time windows 168, 170, 172 may be 30 days or some other time period. In the example shown in FIG. 6, the changepoint 162 may have a post/pre mean ratio of 0.7; changepoint 164 may have a post/pre mean ratio of 0.3; and the changepoint 166 may have a post/pre mean ratio of 0.5. These post/pre mean ratios indicate that step changes in offloading have occurred, at least some of which may be non-seasonal in nature.

The post/pre ratios may be used to determine an envelope shape for an envelope pattern in the loading data. An envelope pattern may be classified in one of a plurality of predetermined envelope shape classes. For example, the predetermined envelope shape classes may include: (a) step down(s)—one or more; (b) step up(s)—one or more; (c) flat—no significant changepoints; and (d) wavy—indicating step up and step-down changes. The foregoing shape classes are not exclusive; additional and/or different shape classes may be used. The shape classes may have corresponding numerical values, such as in a range from [0, 1] or [−1, 1], which may reflect the likelihood of the envelope shape being or not being seasonal in nature. For example, a flat shape class may have a value of 1, indicating lower seasonal probability, while a wavy shape class may have a value of −1, indicating higher seasonal probability. Envelope shape detection may be trained by a machine learning model or may be determined by a heuristic decision tree.

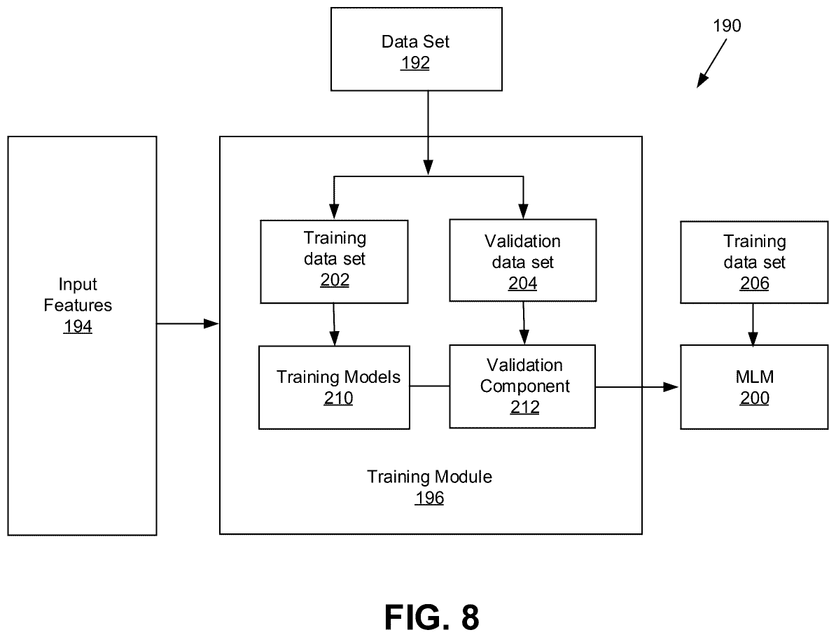

FIG. 7 shows an envelope pattern 170 that has been determined for the plot 158 of the loading data 160. The envelope pattern 170 reflects the calculated post/pre mean ratios described above. The envelope pattern 170 has both two step down changes and one step up change. This envelope pattern 170 may be classified as being wavy and have a value of −1, which may be an indication that at least a portion of the changes in the loading data 160 may be seasonal in nature.

At 116, data for a time period, such as two years, may be decomposed using a Seasonal and Trend decomposition using LOESS (STL) method to look for, by way of example, a yearly pattern. In the STL method, locally fitted regression models are used to decompose the data into seasonal, trend and remainder components. The STL method performs smoothing on the data using LOESS (locally reweighted scatter plot smoothing) in an inner loop and an outer loop. The inner loop iterates between seasonal and trend smoothing, while the outer loop minimizes the effect of outliers. In the inner loop, the seasonal component is calculated first and removed to calculate the trend component. The remainder is calculated by subtracting the seasonal and trend components from the data.

The STL decomposition may be described as: Yₜ=Sₜ+Tₜ+Rₜ, where Sₜ is the seasonal component, Tₜ is the smoothed trend component and Rₜ is the remainder component.

A strength of the seasonal component may be calculated from the variance of the remainder component divided by the variance of the sum of the seasonal component and the remainder component. More specifically, the strength of the trend component may be determined from the following:

$${F}_{S} = max ( 0 , 1 - \frac{Var ( {R}_{t} )}{Var ( {S}_{t} + {R}_{t} )} )$$

where F_{S} is the seasonal strength between 0 and 1. Data with a seasonal strength (F_{S}) close to 0 exhibits almost no seasonality, while data with a seasonal strength (F_{S}) close to 1 will have strong seasonality. The seasonal strength (F_{S}) may be used as an indication of whether there is a seasonal pattern in the loading data.

In addition to calculating the strength of the seasonal component, a season-to-trend percentage may be calculated. For a time window, such as thirty days, the mean of the seasonal component may be compared to the mean of the trend component to calculate a percentage rise of the mean seasonal component to the mean trend component. The season-to-trend percentage may be a rolling measure (e.g., 30 days) of the mean of the seasonal component compared to the mean of the trend component. A maximum of the season-to-trend percentage may be used as an indication of whether there is a seasonal pattern in the loading data.

In some embodiments where less than two years of data is available, a modified STL method may be used. In the modified STL method, the available data, such as for one year, is decomposed using the STL method to look for a shorter seasonal pattern, such as 90 days. Once again, the STL method decomposes the available data into seasonal, trend and remainder components. After decomposition, the seasonal component is low pass filtered using a Fast Fourier Transform (FFT) algorithm. The filtered seasonal component may then be used to calculate the strength of the seasonal component and the season-to-trend percentage, as described above.

In method 100, information from some or all of 108, 110, 112, 114 and 116 may be used at 120 to determine whether detected changepoint(s) was/were caused by (non-) seasonal factor(s), such as an onload(s) or offload(s) of traffic. In some instances, results of some of these processes and/or combinations thereof may be used to make at least an initial, basic determinations that one or more changepoints have been caused by non-seasonal onloads/offloads. For example, if the results at both 108, 110 are negative, i.e., provide no indication of seasonality, the changepoints may initially be determined to be caused by non-seasonal events. Conversely, if the results of one or both at 108, 110 are positive, i.e., provide an indication of seasonality, the changepoints may initially be determined to be caused by seasonal events. Of course, different combinations of the results of 108-116 may be used at 120 to make initial, basic determinations. Such determinations can be performed automatically using logic-based software routines.

In addition to, or in lieu of, the basic determinations described above, determinations may be made at 120 by trained operators viewing graphical representations of the results of the analyses at 108-116 on a display of a user interface of the loading analysis system 12. Such graphical representations may include time series plots of loading data overlayed with representations of detected changepoints and/or analysis windows, such as those described above and shown in FIGS. 3-7. The determinations of an operator may be transmitted to a computing device executing software routine(s) performing the methods described herein. The determinations are received by the computing device and may be used to perform at least a portion of the methods described herein, such as method 300 described below.

In addition to, or in lieu of, the basic determinations and/or the determinations by trained operators described above, a determination may be made based on errors in forecasts made using all possible sets of changepoints (identified as being caused by non-seasonal events), as described more fully below.

The determinations described above may be used offline to train a machine learning model to detect (non-)seasonal loading changes (e.g., offload). Once trained, a determination made by the machine learning model may be used online to detect (non-) seasonal loading changes (e.g. offload). The machine learning model is described more fully below.

As described earlier, determining whether a changepoint is attributable to a (non-) seasonal loading change, may be used to determine whether to rescale the loading data of a cell site 16 before the changepoint and then use the rescaled data to perform a forecast of the loading of the cell site 16. Such rescaling and forecasting may be used online to forecast future loading of the cell site 16 or may be used offline to train and validate the machine learning model and/or improve the function of another determination algorithm. In the latter case, the forecasted data produced by the rescaling and forecasting may be compared to actual historical data for the time period in question to provide a measure of the accuracy of a determination concerning the causes (seasonal or non-seasonal) of detected changepoints.

The rescaling of loading data may be performed by taking the mean of a window of loading data following a changepoint (post) and the mean of a window of the loading data preceding the changepoint (pre) and then calculating a post/pre ratio of the two calculated means. The windows may have a length of a month, or some other time interval. The loading data preceding the changepoint may then be multiplied by the post/pre mean ratio to rescale the preceding data. The rescaling of the loading data may be cumulative if there are multiple changepoints. For example, referring back to the example of FIG. 6, a determination may be made that changepoints 162, 164 are attributable to non-seasonal changes, e.g., network changes. As such, it may be determined that the loading data preceding the changepoints 162, 164 should be rescaled. The post/pre ratio of 0.7 is calculated for the earlier changepoint 162 and a post/pre ratio of 0.3 is calculated for the more recent changepoint 164. The loading data for the time period between the changepoints 162, 164 is multiplied by 0.3, while the loading data for the time period preceding the changepoint 162 is multiplied by 0.7 and then by 0.3, i.e., the loading data preceding the changepoint 162 is multiplied by 0.21.

Both online and offline forecasting of loading of a cell site 16 may be performed by a forecasting component of the LAF system 12. The forecasting component may utilize one or more models for forecasting. Examples of such models include univariate time series forecasting models, such as a moving average (MA) model, an exponential smooth (ETS) model, an autoregressive distributed lag (ADL) model, or an autoregressive integrated moving average (ARIMA) model. Other models may be used as well, such as a Holt-Winters model, a seasonal auto-regressive integrated moving average (SARIMA) model, a long short-term memory (LSTM) model, a gated recurrent unit (GRU) model, or a convolutional neural network (CNN) model. Forecasting permits the deployment and modification of infrastructure in a timely and cost-effective manner.

A forecast error may be calculated from the forecasted data and actual historical data for the time period using an error calculation algorithm, such as a mean absolute error (MAE) algorithm, a root mean square error (RMSE) algorithm, a root mean squared percentage error (RMPSE) algorithm or a mean absolute percentage error (MAPE) algorithm.

As mentioned above, a machine learning model (MLM) 200 may be provided and trained to detect non-seasonal loading changes (e.g., offload) associated with changepoints. The MLM 200 may be part of a model component 190 of the LAF system 12. The MLM 200 may be a multiclass classification model that may be a linear model, a nonlinear decision tree model or a neural model. The MLM 200 uses features such as those from 108-116 to classify changepoints that have been detected in a sample of loading data. The classes may be different sets of changepoints. For example, if there is a sample in which changepoints 0, 1 and 2 are detected, the classes (sets) of changepoints may be: [none], [0], [1], [2], [0, 1], [0, 2] and [1, 2]. The MLM 200 determines which set of changepoints the sample of loading data should be assigned to. This determination is based on the set that produces the smallest forecasting error when the changepoint(s) (if any) in the set are used to rescale the loading data before the forecasting is performed.

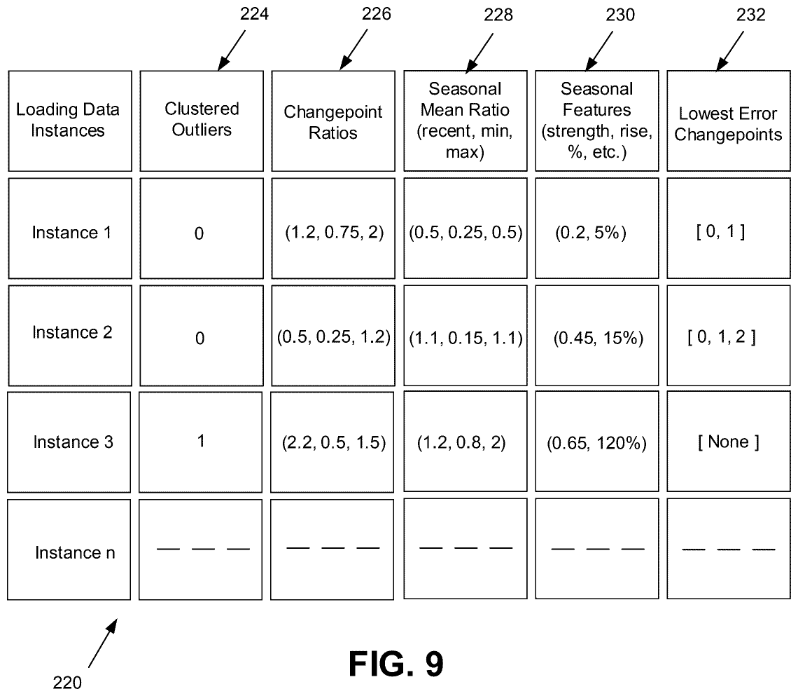

Referring now to FIG. 8, there is shown a schematic diagram of an instance of the model component 190 of the LAF system 12. The model component 190 may generally include a data set 192, model input features 194, a training module 196 and MLM 200. The training module 196 may include one or more training models 210.

The data set 192 may include data vectors obtained from different instances of loading data from a plurality of cell sites 16 using the methods described above. Each instance may before an extended period of time, such as one, two or more years. The data set 192 may be split into a training data set 202, a validation data set 204 and a test data set 206, which are separate from each other. The split of the data set 192 may, by way of example, be: 80% to the training data set, 15% to the validation data set and 5% to the test data test. Of course, other data splits may be used; however, the training data set should comprise most of the data set. The training data set and the validation data set are used in the training module, as described below.

The model input features may include some or all features from the method 100 at 108-116. More specifically, the input features may include: temporal spacing of changepoints, clustered outliers in a time window, temporal spacing of clusters of outliers, changepoint post/pre ratios, seasonal mean ratios (recent, min, max), seasonal strength and season-to-trend percentage.

In some instances, the training module may apply machine learning to the training data set to generate an importance score for each of the input features, wherein the importance score indicates the importance of the feature relative to a finding of (non-) seasonality of a changepoint. The input features may be ranked based on their importance scores. One or more training models 210 may use the most important features to determine the changepoints that are most likely caused by non-seasonal events and for which rescaling should be performed. A validation component 212 may evaluate the training models using the validation set and may select the training model 210 that performs best on the validation data to be the MLM 200.

The test data set 206 may be used to test the performance of the MLM 200 to provide a performance metric with regard to the accuracy and precision of the MLM 200.

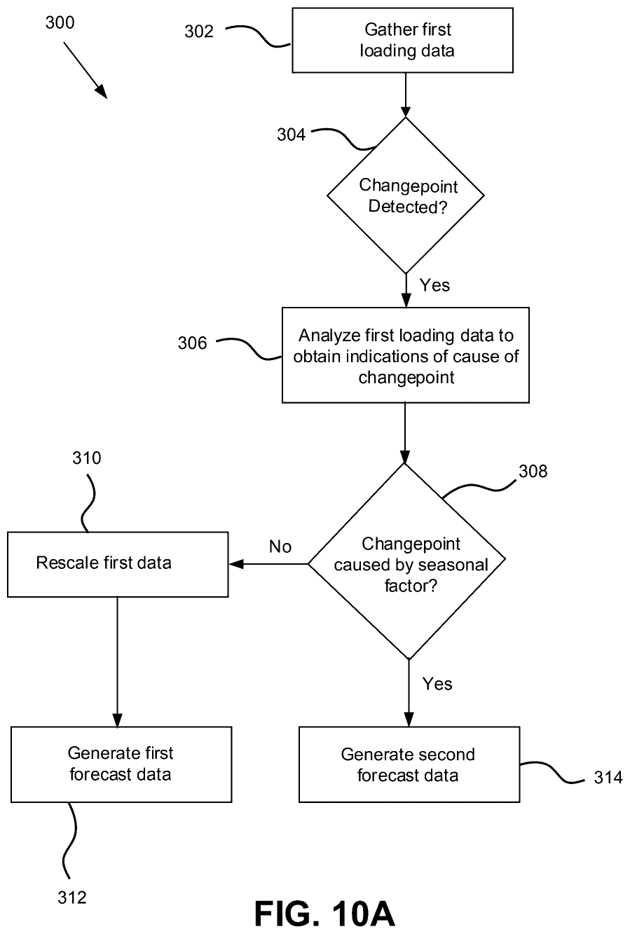

Referring now to FIG. 9, there is shown a training data set 220 that may be used to train a training model 210. The training data set 220 shows data for Instance 1, Instance 2 and Instance 3, which may be different instances of loading data from a plurality of cell sites 16. The Instance n signifies that additional, different instances of loading data from cell sites 16 may be included, but are not shown. In each of the Instances 1, 2, 3, changepoints 0, 1, 2 have been detected. Values for features 224, 226, 228, 230 are located in second through fifth columns, below their respective identifiers. Feature 224 is “Clustered Outliers”, which are the changepoints that have clustered outliers; Feature 226 is “Changepoint Ratios”, which are the post/pre ratios for the three changepoints; Feature 228 is “Seasonal Mean Ratio (recent, min, max)”, which are the most recent seasonal mean ratio, the minimum of all the calculated seasonal mean ratios and the maximum of all the calculated seasonal mean ratios; and Feature 230 “Seasonal Features (strength, rise % etc.)”, wherein the seasonal strength, as described above, is between 0 and 1 and the rise % is the percentage rise of the mean seasonal component compared to the mean of the trend component. It should be appreciated that the input features 224, 226, 228, 230 are not limiting. In other implementations, additional and/or different calculable indicators may be used for input features.

The values for the input features 224, 226, 228, 230 in the training data set 220 may be obtained from the method 100 at 108-116.

A classification 232 is in the sixth column of the training data set 22. The classification 232, identified as “Lowest Error Changepoints”, is the set of changepoints that are determined to produce the smallest forecasting error when the changepoint(s) (if any) in the set are used to rescale the loading data before the forecasting is performed. The set of changepoints may be determined from the basic determinations described above and/or the determinations by trained operators described above and/or by an iterative process in which rescaled instances of loading data are calculated for all possible sets (classes) of changepoints (identified as being caused by non-seasonal events). These instances of rescaled loading data may be used to generate corresponding instances of forecast data, which are then compared to actual historical data to obtain a plurality of errors. The set (class) of changepoints that produces the lowest error may then be selected. Of course, for the possible set (class) of changepoints having no members, no rescaling is performed to generate its instance of forecast data.

As shown, the values in the column for classification 232 indicate the following: in Instance 1, the two changepoints 0 and 1 indicate non-seasonal loading changes and the loading data preceding these changepoints should be rescaled; in Instance 2 all three changepoints 0, 1 and 2 indicate non-seasonal loading changes and the loading data preceding these changepoints should be rescaled; and in Instance 3, none of the three changepoints indicate non-seasonal loading changes and, thus, no rescaling should be performed.

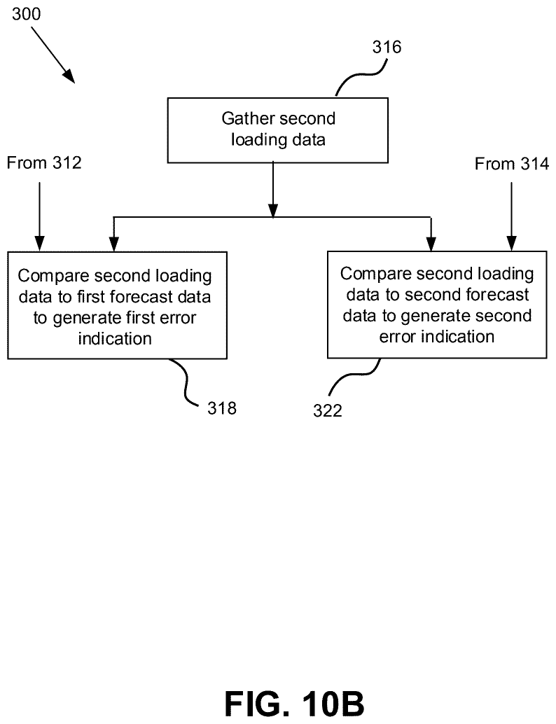

Referring now to FIGS. 10A and 101B, there is shown a method 300 in accordance with the techniques provided herein. At 302, first loading data is gathered from a cell site 16 for a first period of time. At 304, the first loading data is analyzed for changepoints and based on this analysis a determination is made that there is a changepoint in the loading data. At 306, the first loading data is analyzed to obtain indications of a cause of the changepoint. At 308, based on the obtained indications, a determination is made whether the changepoint is attributable to a seasonal factor. If, at 308, the determination is that the changepoint is not attributable to a seasonal factor, the first loading data before the changepoint is rescaled at 310. At 312, the first loading data that is rescaled is used to generate first forecast data for a second time period, which follows the first time period. If, at 308, the determination is that the changepoint is attributable to a seasonal factor, the first loading data is not rescaled and is used at 314 to generate second forecast data for a second time period, which follows the first time period.

The method 300 may further include at 316 gathering second loading data from the cell site for the second time period. If, at 308, the determination is that the changepoint is not attributable to a seasonal factor, the second data, at 318, may be compared to the first forecast data generated at 312 to calculate a first error indication. If, at 308, the determination is that the changepoint is attributable to a seasonal factor, the second data, at 322, may be compared to the second forecast data generated at 314 to calculate a second error indication.

Although not shown, the method 300 may further include re-performing the method after 308, but using a determination at 308 opposite to that previously made based on the obtained indications, e.g., determining that the changepoint was caused by a seasonal factor when it was previously determined not to be. In this manner, the first error indication and the second error indication are both calculated. The first error indication and the second error indication may then be compared and the smaller of the two chosen. The determination at 308 corresponding to the smallest error may then be used to train a machine learning model, such as a training model 210.

The analysis of the first loading data at 306 may include any and all of the techniques disclosed herein, including some or all the techniques of the method 100 at 108-116. Other techniques may also be used.

If the method 300 is used to train a machine learning model offline, the initial determination at 308 may be made using the computer-implemented basic determinations described above and/or the determinations of trained operators described above. If the method 300 is used, such as online, to make a forecast in the future, the determination at 308 may be made using the computer-implemented basic determinations described above and/or the determinations of trained operators described above, and/or by the MLM 200.

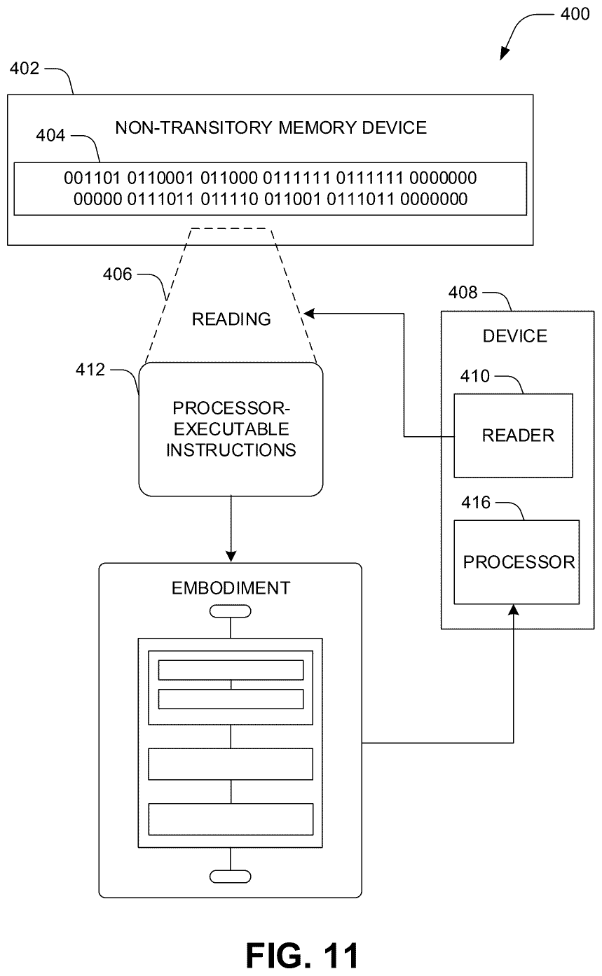

FIG. 11 is an illustration of a scenario 400 involving an example non-transitory machine readable medium 402. The non-transitory machine readable medium 402 may comprise processor-executable instructions 412 that when executed by a processor 416 cause performance (e.g., by the processor 416) of at least some of the provisions herein. The non-transitory machine readable medium 402 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 402 stores computer-readable data 404 that, when subjected to reading 406 by a reader 410 of a device 408 (e.g., a read head of a hard disk drive, or a read operation invoked on a solid-state storage device), express the processor-executable instructions 412. In some embodiments, the processor-executable instructions 412, when executed cause performance of operations, such as at least some of the example methods 100, 300 of FIGS. 2A, 2B and FIGS. 10A, 10B.

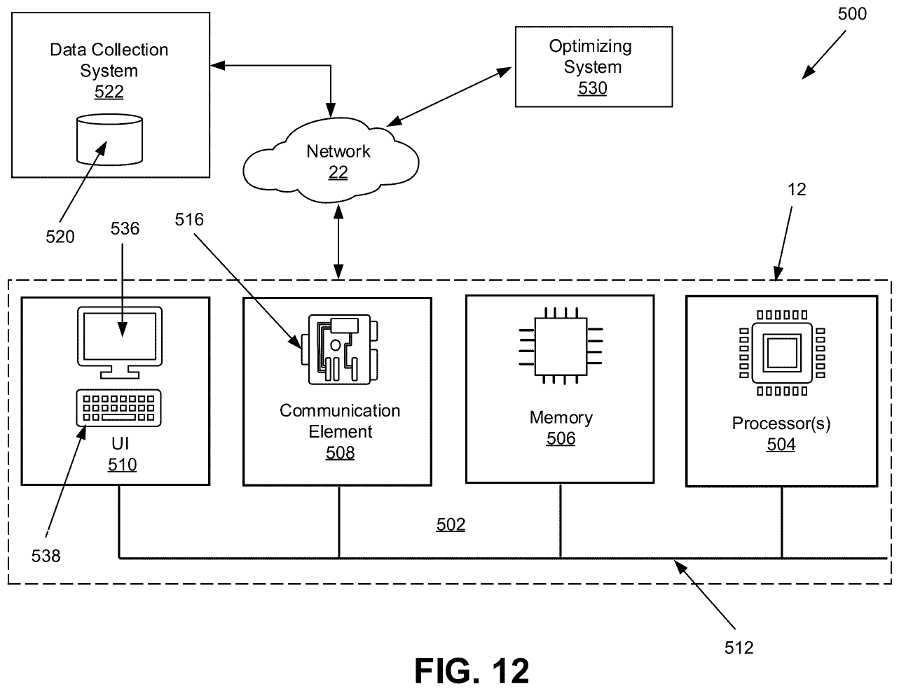

FIG. 12 shows an example environment 500 in which systems and/or methods described herein may be implemented. The environment 500 includes the LAF system 12, which may include a computing device 502 for performing all or a portion of the methods disclosed herein, include methods 100, 300. The computing device 502 may include one or more processors 504, memory 506, a communication element 508 and a user interface (UI) 510, all of which may be connected together by a bus 512. The processor(s) 504 may include multiple processors arranged into processing units, such as a central processing unit (CPU) and a graphics processing unit (GPU). The processor(s) 504 may execute instructions stored in a machine-readable, non-transitory medium, such as memory 506.

Memory 506 may include long-term memory, short-term memory, cache and/or a data storage unit. Memory 506 may store data, such as data gathered from cell sites 16, and instructions, such as instructions for performing all or a portion of the methods 100, 300.

The communication element 508 enables the computing device 502 to communicate with other devices through a wired connection, a fiber optic connection and/or a wireless connection. For example, the communication element 508 may include a wireless transceiver, a fiber optic transceiver, a cable transceiver and a network interface 516. The communication element 508 may further include an antenna.

Using the communication element 508 (e.g., network interface 516), the computing device 502 may access data stored in a data repository 520 of a data collection system 522 connected to the network 22. The data collection system 522 may automatically collect and store all historical data from the cell sites 16. An optimizing system 530 may also be connected to the network 22 to receive scaled loading data and/or forecasted loading data from the computing device 502 through the communication element 508.

The optimizing system 500 may, by way of example, use scaled loading data and/or forecasted loading data to optimize a cell site 16 or a network, such as by optimizing the radio frequency (RF) coverage footprints of one or more of the cell sites 16 to minimize interference while assuring enough overlap for handovers. Such optimization or “RF shaping” may involve physical configuration changes to one or cell sites 16, such as by changing RF power and the azimuth and elevation of antennas.

The user interface 510 enables the computing device 502 to receive input from a user and to provide output to a user. For example, the user interface 510 may include a display screen 536 upon which a user may view a data plot, such as plots 130, 134, 140, 158, 170 described above. The user interface 510 may further include a keyboard 538, keypad, touch screen and/or a microphone to input information from a user, such as determinations concerning the causes of changepoints in loading data.

In another example environment (not shown), the computing device 502 may be used in a cloud computing system within which the LAF system 12 may execute. The cloud computing system may, in addition to the computing device 502, may include a resource management component and a host operating system (OS). The cloud computing system may, by way of example, execute on an Amazon Web Services platform, a Microsoft Azure platform or a Google Cloud Platform. The resource management component may perform virtualization of the computing device 502 to create a plurality of virtual computing systems, thereby permitting the computing device 502 to operate more efficiently, with lower power consumption, higher reliability, higher utilization and greater flexibility.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method performed by a computing device, comprising:
gathering time-series first data from a wireless cell site, the first data being indicative of loading of the wireless cell site;
detecting a changepoint in the first data;
statistically analyzing the first data to obtain indications relating to a cause of the changepoint, the cause comprising at least one of a seasonal loading change or a non-seasonal loading change; and
identifying the cause of the changepoint based on the indications.

2. The method of claim 1, wherein the first data comprises average active connections.

3. The method of claim 1, comprising:
utilizing the first data based on the identifying of the cause of the changepoint.

4. The method of claim 3, wherein the identifying the cause of the changepoint comprises identifying the non-seasonal loading change as the cause of the changepoint; and
wherein the utilizing the first data comprises mathematically adjusting the first data to account for the non-seasonal loading change.

5. The method of claim 4, wherein the adjusting the first data comprises rescaling a portion of the first data obtained before the changepoint to obtain scaled first data.

6. The method of claim 5, wherein the first data is for a first time period; and
wherein the method comprises generating forecast data from the scaled first data, the forecast data being for a second time period following the first time period.

7. The method of claim 6, comprising:
gathering second data from the wireless cell site;
calculating a forecast error from the forecast data and the second data; and
using the forecast error to train a machine learning model.

8. The method of claim 3, wherein the identifying the cause of the changepoint comprises identifying the seasonal loading change as the cause of the changepoint; and
wherein the utilizing the first data comprises creating generated data.

9. The method of claim 8, wherein the generated data comprises forecast data for a second time period following the first time period.

10. The method of claim 9, wherein the first data is for a first time period; and
wherein the generated data comprises forecast data for a second time period following the first time period.

11. The method of claim 1, wherein the analyzing the first data comprises:
calculating a ratio of a mean of the first data after the changepoint to a mean of the first data before the changepoint to yield a changepoint mean ratio, which comprises a first one of the indications; and
calculating a seasonal ratio of a mean of the first data in a first time window and a mean of the first data in a second time window, wherein the first time window is separated from the second time window by a time period that is longer than the first time window and the second time window, the seasonal ratio comprising a second one of the indications.

12. The method of claim 11, wherein the analyzing the first data comprises:
decomposing the first data into a seasonal component and a trend component;
determining a strength of the seasonal component, which comprises a third one of the indications;
determining a mean of the seasonal component and a mean of the trend component; and
calculating a percentage rise of the mean of the seasonal component to the mean of the trend component, which comprises a fourth one of the indications.

13. The method of claim 12, wherein the analyzing the first data comprises:
detecting a first cluster of outlier data in the first data, which comprises a fifth one of the indications.

14. The method of claim 13, wherein the analyzing the first data comprises:
detecting a second cluster of outlier data in the first data; and
determining a temporal spacing between the first cluster of outlier data and the second cluster of outlier data, which comprises a sixth one of the indications.

15. The method of claim 1, wherein the identifying the cause of the changepoint comprises executing a multiclass classification software model on the computing device.

16. A method performed by a computing device, comprising:
gathering time-series first data from a wireless cell site for a first time period;
detecting a changepoint in the first data;
statistically analyzing the first data to obtain indications relating to a cause of the changepoint;
identifying the cause of the changepoint based on the indications; and
utilizing the first data based on the identifying of the cause of the changepoint, the utilizing the first data comprising at least one of creating generated data or adjusting the first data.

17. The method of claim 16, wherein the identifying the cause of the changepoint comprises identifying a non-seasonal event as the cause of the changepoint;
wherein the utilizing the first data comprises the adjusting the first data to obtain adjusted first data; and
wherein the method comprises generating forecast data from the adjusted first data, the forecast data being for a second time period following the first time period.

18. The method of claim 16, wherein the identifying the cause of the changepoint comprises identifying a seasonal event as the cause of the changepoint;
wherein the utilizing the first data comprises the creating the generated data; and
wherein the generated data comprises forecast data for a second time period following the first time period.

19. The method of claim 16, wherein the analyzing the first data comprises:
calculating a ratio of a mean of the first data after the changepoint to a mean of the first data before the changepoint to yield a changepoint mean ratio, which comprises a first one of the indications;
calculating a seasonal ratio of a mean of the first data in a first time window and a mean of the first data in a second time window, wherein the first time window is separated from the second time window by a time period that is longer than the first time window and the second time window, the seasonal ratio comprising a second one of the indications;
decomposing the first data into a seasonal component and a trend component;
determining a strength of the seasonal component, which comprises a third one of the indications;
determining a mean of the seasonal component and a mean of the trend component; and
calculating a percentage rise of the mean of the seasonal component to the mean of the trend component, which comprises a fourth one of the indications.

20. A computing device comprising:
one or more processors configured to execute instructions to perform operations comprising:
gathering time-series first data from a wireless cell site, the first data being indicative of loading of the wireless cell site;
detecting a changepoint in the first data;
statistically analyzing the first data to obtain indications relating to a cause of the changepoint, the cause comprising at least one of a seasonal event or a non-seasonal event; and
identifying the cause of the changepoint based on the indications.
